(19) United States
(12) Patent Application Publication
(10) Pub. No.: US 2016/0239583 A1
(43) Pub. Date: Aug. 18, 2016

(54) METHOD AND SYSTEM FOR COMPONENT DESIGN AND VALIDATION

(71) Applicant: Caterpillar Inc., Peoria, IL (US)

(72) Inventor: Luke Joseph Daiberl, Wheaton, IL (US)

(73) Assignee: CATERPILLAR INC., Peoria, IL (US)

(21) Appl. No.: 14/620,253

(22) Filed: Feb. 12, 2015

(51) Int. Cl. G06F 17/50

(52) U.S. Cl. CPC G06F 17/50

(57) ABSTRACT

A system for designing and validating a component is disclosed. The system may have an interface device configured to receive desired geometry, required geometric dimensions and tolerances for the desired geometry, and a metrology plan associated with the component. The system may also have at least one database, a display, and a processor. The processor may be configured to render a 3-D engineering model of the component on the display based on the desired geometry and the required geometric dimensions and tolerances, and to store the 3-D engineering model and the metrology plan in the at least one database. The processor may also be configured to communicate the 3-D engineering model and the metrology plan to a supplier, to receive from the supplier metrology data corresponding to the metrology plan and associated with the component, and to render a 3-D metrology model of the component based on the metrology data.

### TECHNICAL FIELD

The present disclosure relates generally to a design method and system, and more particularly, to a method and system for designing and validating a component.

### BACKGROUND

Historically, components of machines have been created through a difficult and cumbersome process that can result in error and waste. For example, an engineer typically created a 3-D electronic model of the component showing desired geometry. The engineer or an assisting draftsman then converted the model to a 2-D line drawing. Geometric dimensions and tolerances were added to the drawing, and the drawing was then sent through a purchasing representative to a supplier. A tool designer interpreted the drawing to create tooling used to make the component. Once the component was made, an inspector interpreted the drawing to manually create a metrology plan used to inspect the component. After completion of the metrology plan, the supplier measured the component and created a 2-D metrology report that was returned to the purchasing representative. The purchasing representative, together with the engineer, interpreted the report and either approved the supplier for continued use in providing the part, allowed for deviations from the original requirements, or rejected the supplier. Opportunities for error introduction were possible in creation of the drawing, interpretation of the drawing, creation of tooling, measuring of the component, creation of the metrology report, and interpretation of the report. In addition, because the process was so long and cumbersome, it was not always followed completely. Further, storage of the model, the drawing, and the reports was difficult to control, and led to unauthorized changes and loss of data over time.

The disclosed method and system are directed toward overcoming one or more of the problems set forth above and/or other problems of the prior art

### SUMMARY

In one aspect, the present disclosure is directed to a system for designing and validating a component. The system may include an interface device configured to receive from a user desired geometry of the component, required geometric dimensions and tolerances for the desired geometry, and a metrology plan associated with the component. The system may also include at least one database, a display, and a processor in communication with the interface device, the at least one database, and the display. The processor may be configured to render a 3-D engineering model of the component on the display based on the desired geometry and the required geometric dimensions and tolerances, and to store the 3-D engineering model and the metrology plan in the at least one database. The processor may also be configured to communicate the 3-D engineering model and the metrology plan to a supplier, to receive from the supplier metrology data corresponding to the metrology plan and associated with the component, and to render a 3-D metrology model of the component based on the metrology data.

In another aspect, the present disclosure is directed to another system for designing and validating a component. This system may include an interface device configured to receive from a user desired geometry of the component, required geometric dimensions and tolerances for the desired geometry, and a metrology plan associated with the component. The system may also include an engineering database, a purchasing database, a display, and a processor in communication with the interface device, the engineering database, the purchasing database, and the display. The processor may be configured to render a 3-D engineering model of the component on the display based on the desired geometry, to show on the display the required geometric dimensions and tolerances in conjunction with the 3-D engineering model, to create a 2-D drawing of the component based on the 3-D engineering model, and to render a 3-D metrology plan model based on the 3-D engineering model and the metrology plan. The processor may also be configured to communicate the 3-D engineering model, the 3-D metrology plan model, and the 2-D drawing to a supplier, and to receive from the supplier metrology data corresponding to the metrology plan and associated with the component. The processor may be further configured to render a 3-D metrology model based on the metrology data, to show the 3-D metrology model overlaid on the 3-D engineering model, to store the 3-D engineering model in the engineering database, and to store the 3-D metrology plan model, the 3-D metrology model, and the 2-D drawing in the purchasing database.

In a further aspect, the present disclosure is directed to a method of designing and validating a component, the method comprising steps performed by one or more processors. The steps may include receiving from a user desired geometry of the component, required geometric dimensions and tolerances for the desired geometry, and a metrology plan associated with the component. The steps may further include rendering a 3-D engineering model of the component based on the desired geometry, displaying the required geometric dimensions and tolerances in conjunction with the 3-D engineering model, creating a 2-D drawing of the component based on the 3-D engineering model, and rendering a 3-D metrology plan model based on the 3-D engineering model and the metrology plan. The steps may also include transmitting the 3-D engineering model, the 3-D metrology plan model, and the 2-D drawing to a supplier, receiving from the supplier metrology data corresponding to the metrology plan and associated with the component, and rendering a 3-D metrology model based on the metrology data. The steps may additionally include showing the 3-D metrology model overlaid on the 3-D engineering model, and storing the 3-D engineering model, the 3-D metrology plan model, the 3-D metrology model, and the 2-D drawing in at least one database.

### BRIEF DESCRIPTION OF THE DRAWINGS

FIGS. 1-4 are isometric illustrations of different exemplary models of a component; and

FIG. 5 is a diagrammatic illustration of an exemplary disclosed system that may be used to design and validate the component.

### DETAILED DESCRIPTION

The disclosed methods and systems are explained below in relation to a specific component. The component is shown and described as being an air induction tube for a combustion engine. It should be noted, however, that other and different components may similarly be designed and validated with the disclosed methods and systems. Accordingly, the disclosed component should be considered exemplary only.

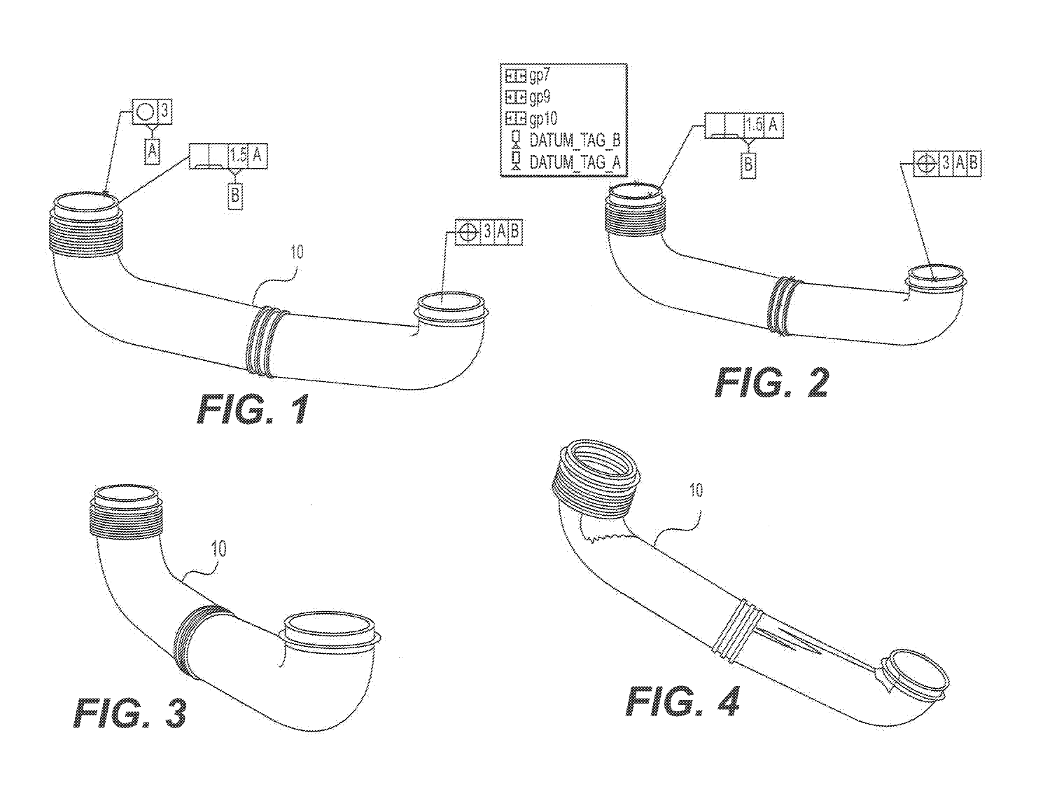

FIGS. 1-4 represent 3-D models of an exemplary component 10. In the disclosed embodiment, component 10 is a tube having an upstream end configured to connect to an air cleaner arrangement mounted on a machine body, and a downstream end configured to connect to a turbocharger of an engine located inside the machine body. In this embodiment, various dimensions of component 10 may be critical to making a proper connection between the air cleaner arrangement and the turbocharger, as well as to facilitating low-restriction fluid flow.

The illustrations of FIGS. 1-3 each represent a different type of 3-D model, while the illustration of FIG. 4 represents overlapping models from FIGS. 1 and 3. In particular, FIG. 1 represents an engineering model of component 10 in a theoretical state; FIG. 2 represents a metrology plan model associated with component 10; and FIG. 3 represents a metrology model of component 10 in an actual as-manufactured state. FIG. 4 shows the actual state of component 10 overlaid with the theoretical state, wherein the areas of shading illustrate differences between the states.

The 3-D engineering model of component 10 shown in FIG. 1 can be generated using commercially available design software, for example, Pro/ENGINEER, PTC Creo, CATIA, SOLIDWORKS, AutoCAD, and others. A user (e.g., an engineer or draftsman) creates the model shown in FIG. 1 by inputting parameters (e.g., locations, orientations, dimensions, contours, etc.) for desired geometry, linking the parameters together in a designated coordinate system, and providing characteristics (e.g., material properties, surface textures, colors, etc.) for the geometry. The software includes programmable instructions that, when executed by a processor, renders the 3-D engineering model based on the received information.

In some instances, the same or different design software may allow the user to constrain actual features of component 10 relative to one or more virtual references (e.g., datum references). In particular, the user is allowed to define a virtual plane, line, point, and/or axis as a reference, and the actual features of component 10 may deviate somewhat in position, size, orientation, and/or shape from the ideal relative to the reference within defined limits. In other words, the user assigns geometric dimensions and tolerances (a.k.a., GD&T) for the features of component 10 relative to one or more defined references, and the 3-D engineering model of FIG. 1 may include this information. When validating component 10 (i.e., when checking to see if an as-manufactured component adequately matches the theoretical component), measurements taken from the as-manufactured component are compared with some or all of the GD&T defined in the engineering model. Depending on the exact software used to create the engineering model, the GD&T may be rendered along with the form of component 10, may be selectable and modifiable, and/or only presented only under select conditions (e.g., only when specifically requested by the user).

In order to validate a manufactured component, the manufactured component must be measured. Conventionally, the manufactured component is measured based on the GD&T assigned by the user that created the engineering model in a manner suitable to the supplier. In some instances, it may be necessary to perform a measurement corresponding to every GD&T. In other instances, only a subset of GD&T are critical and, accordingly, fewer measurements may be necessary in these instances. In the disclosed embodiment, however, the user creates a metrology plan that defines which (and in some instances how) measurements are required and should be made. In the disclosed embodiment, the metrology plan is defined electronically and tied to the 3-D engineering model of component 10 to create the metrology plan model shown in FIG. 2.

In one example, the metrology plan model is created by allowing the user to select for validation purposes particular requirements from the GD&T already shown on the engineering model, depending on what the user deems to be critical. For example, the user may select a requirement for flatness from a main portion of the engineering model. The user may then select how flatness of a particular surface should be measured (e.g., relative to which datum references, number of inspection points, locations of inspection points, order of inspection points, type of inspection apparatus, inspection conditions, etc.). This information is then rendered together with the form of the component as the metrology plan model. For example, inspection sequences may be shown in a window near the model, inspection points may be illustrated on the model, datum references may be high-lighted, etc. During actual inspection of a manufactured component, as the measurements are being taken, the metrology plan model may be updated and show different information. For example, completed inspections may be removed from the plan or otherwise marked as completed, the next inspection process to be performed may be highlighted, etc. It is contemplated that the metrology plan model may not include all of the component form and/or information included in the engineering model, if desired. For example, the metrology plan model could include information only pertinent to the inspection that will be performed (i.e., some surfaces, dimensions, material properties, and/or features normally included in the engineering model may be omitted from the metrology plan model).

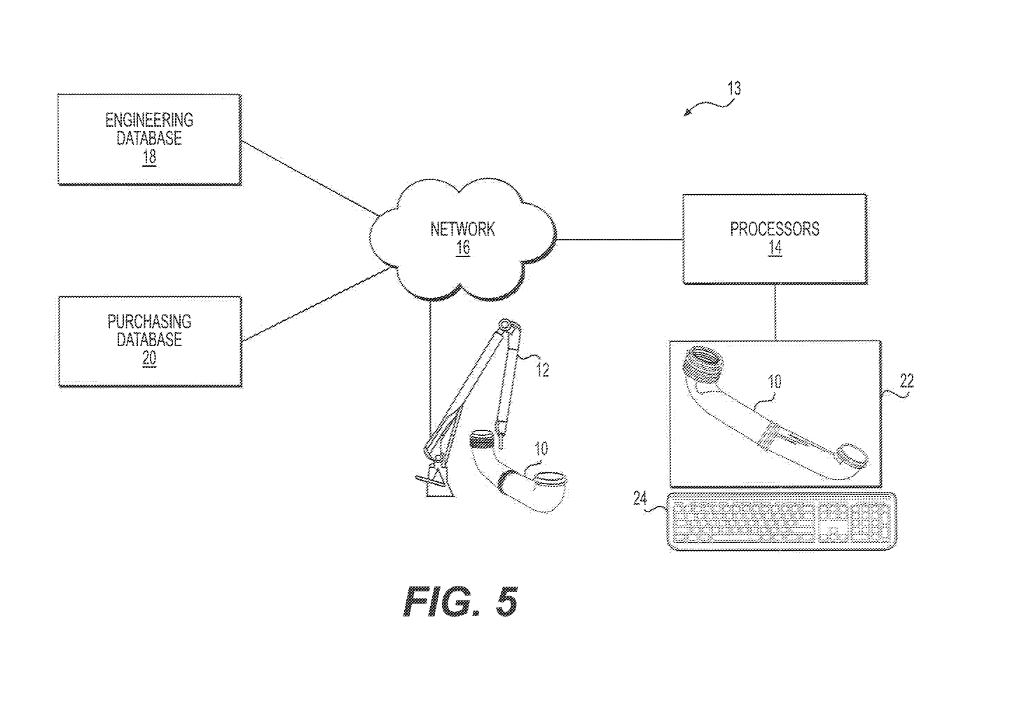

During and/or after inspection of the manufactured component using the metrology plan model and an appropriate inspection device 12, the measurement data collected from the process is used to create the metrology model showing the actual form of component 10. In particular, the same or different software may be used to create a 3-D model of the actual imperfect features of component 10. In some instances, a scanner is used to capture complete surfaces of the component and to directly create therefrom the 3-D model. In other instances, data points captured from a probe-equipped inspection arm (shown only in FIG. 5) are used to stitch together the surfaces of component 10 and create the 3-D model. Other methods known in the art may also be possible.

The 3-D metrology model may be laid over the 3-D engineering model, as shown in FIG. 4, such that the user may visually detect how the actual component deviates from the theoretical component. Specifically, the two models may be rendered in different colors, such that the deviations are readily apparent as shaded regions on the engineering model. In some instances, the deviations may also be color coded, such that a greater deviation from the theoretical component is shown in a color different from a lesser deviation. Additionally or alternatively, when a deviation exceeds the GD&T set forth by the user in a previous operation, attention may be brought to that deviation. For example, the excessive deviation may be highlighted in a particular manner.

FIG. 5 illustrates an exemplary disclosed system 13 used to automatically generate each of the different models described above (referring to FIGS. 1-4). System 13 includes one or more computer processors (or other hardware) 14 and software applications (or other software) executable by processor(s) 14 to perform certain functions related to model creation. These functions include, but are not limited to, generating, maintaining, updating, deleting, rendering, analyzing, and/or presenting different design configurations of component 10.

Processor(s) 14 is connected, for example via a network 16, to one or more databases. These data bases include, among others, an engineering database 18 that contains information regarding the theoretical form of component 10 and the engineering model, and a purchasing database 20 that contains information regarding the actual form of component 10, the metrology plan model, and the metrology model. Network 16 may be any type of wired or wireless communication network for exchanging or delivering information or signals, such as the internet, a wireless local area network (LAN), or any other network. In some embodiments, the inspection device 12 described above may be plugged into network 16 to receive theoretical component information from and supply actual component information to processor 14 and/or data bases 18, 20. In other embodiments, this information may be communicated via other non-network means, for example via portable memory devices.

Processor(s) 14 has a memory and a transceiver, and is associated with a display 22 and an interface device 24. The memory is configured to store information used by processor(s) 14, e.g., computer programs or code executed by processor(s) 14 to enable processor(s) 14 to perform functions consistent with this disclosure. The memory includes one or more memory devices including, but not limited to, a storage medium such as a read-only memory (ROM), a flash memory, a dynamic or static random access memory (RAM), a hard disk device, an optical disk device, etc. The transceiver includes one or more devices that transmit and receive data, such as data processed by processor(s) 14 and/or stored by the memory.

Processor(s) 14 is configured to receive data (e.g., from the databases listed above and/or from the user), and to responsively process information stored in the memory. Processor(s) 14 may be configured with different types of hardware and/or software (e.g., a microprocessor, a gateway, a product link device, a communication adapter, etc.). Further, processor(s) 14 may execute software for performing one or more functions consistent with the disclosed embodiments. Processor(s) 14 may include any appropriate type of general purpose microprocessor, digital signal processor, or microcontroller.

Display 22 includes one or more monitors (e.g., a liquid crystal display (LCD), a cathode ray tube (CRT), a personal digital assistant (PDA), a plasma display, a touch-screen, a portable hand-held device, or any such display device known in the art) configured to actively and responsively display information (e.g., the engineering model, the metrology plan model, the metrology model, etc.) to the user of system 13. Interface device 24 may include any combination of keyboard, mouse, light pen, track ball, touchpad, joystick, etc., that is configured to receive input from the user.

It should be noted that a different number and/or different types of databases may be included within system 13 and utilized by processor 14, if desired. For example, engineering database 18 and purchasing database 20 may be broken into multiple different databases or, alternatively, combined within a single database. It is further contemplated that the information described above as being stored in the different databases may additionally or alternatively be stored within the memory of processor(s) 14 or elsewhere on network 16, if desired.

### INDUSTRIAL APPLICABILITY

The disclosed system may be used to design and validate components via a simple and robust process that reduces potential error and waste. The disclosed design and validation process may be used to generate new components with reduced man hours and associated cost, find reliable suppliers of the components, and help ensure that the components are manufactured to desired specifications. Operation of system 13 will now be described with reference to FIGS. 1-5.

Processor(s) 14 receives desired geometry of component 10, required GD&T, and the metrology plan from the user of system 13 by way of a graphics user interface (GUI) associated with display 22 and interface device 24, and automatically renders the different models of FIGS. 1 and 2, as well as the associated 2-D component drawing. The engineering model and metrology plan model are then stored in engineering and purchasing databases 18, 20, respectively.

The engineering and metrology plan models, as well as the 2-D drawing, are then selectively retrieved from databases 18, 20 and communicated to prospective suppliers. The suppliers then responsively generate tooling and manufacture sample components based on the engineering model and the 2-D drawing, and capture metrology data based on the metrology plan model during an ensuing inspection process of as-manufactured components 10. It should be noted that, in some instances, the tooling may be generated by the user and supplied to the supplier, or generated by a third party, if desired. The metrology data is captured via inspection device 12 and returned to processor(s) 14 as 3-D information used to create the metrology model. Processor(s) 14 then generates 2-D information based on the 3-D model, and stores the model along with the 2-D information in purchasing database 20. It is contemplated that, in some instances, the user may generate the metrology model themselves, based on information provided by the supplier.

After both the engineering and metrology data models have been created, the two models may be shown in an overlapping manner on display 22 by processor 14. This may allow the user to visually discern discrepancies between the theoretical and actual components 10. In some embodiments, processor 14 may automatically grade the discrepancies. For example, processor 14 may cause the discrepancies to be shown differently based on a deviation magnitude away from the theoretical component. These discrepancies, as well as the grading, may also be stored in purchasing database 20.

In some applications, processor(s) 14 is configured to automatically approve particular suppliers for continued use based on the discrepancies and/or grading discussed above. In other instances, the user may manually make this approval based on the rendered information. For example, a particular supplier may be automatically approved for continued use in manufacturing component 10 when the discrepancies are less than a desired amount, and automatically rejected when the discrepancies are higher than the desired amount. In another example, a deviation from the required GD&T may be requested when the discrepancies are associated with features that are deemed to be less critical. It is contemplated that the supplier approval status and/or deviation requests may also be stored in purchasing database 20, if desired.

It will be apparent to those skilled in the art that various modifications and variations can be made to the methods and systems described above. Other embodiments will be apparent to those skilled in the art from consideration of the specification and practice of the disclosed methods and systems. It is intended that the specification and examples be considered as exemplary only, with a true scope being indicated by the following claims and their equivalents.

What is claimed is:

1. A method of designing and validating a component, the method comprising the following steps performed by one or more processors:
receiving from a user:
desired geometry of the component;
required geometric dimensions and tolerances for the desired geometry; and
a metrology plan associated with the component;
rendering a 3-D engineering model of the component based on the desired geometry;
rendering a 3-D metrology plan model based on the 3-D engineering model and the metrology plan;
transmitting the 3-D engineering model and the 3-D metrology plan model to a supplier;
receiving from the supplier a 3-D metrology model corresponding to the metrology plan and associated with the component; and
generate metrology data based on the 3-D metrology model.

2. The method of claim 1, further including displaying the required geometric dimensions and tolerances in conjunction with the 3-D engineering model.

3. The method of claim 2, further including showing the 3-D metrology model overlaid on the 3-D engineering model.

4. The method of claim 3, further including grading the component based on differences between the 3-D metrology model and the 3-D engineering model.

5. The method of claim 4, further including selectively approving the supplier based on the grading.

6. The method of claim 5, further including storing the 3-D engineering model, the 3-D metrology plan model, the 3-D metrology model, and the grading in at least one database.

7. The method of claim 1, further including:
creating a 2-D drawing of the component based on the 3-D engineering model; and
transmitting the 2-D drawing to the supplier.

8. A system for designing and validating a component, comprising:
an interface device configured to receive from a user:
desired geometry of the component;
required geometric dimensions and tolerances for the desired geometry; and
a metrology plan associated with the component;
at least one database;
a display; and
a processor in communication with the interface device, the at least one database, and the display, the processor being configured to:
render a 3-D engineering model of the component on the display based on the desired geometry and the required geometric dimensions and tolerances;
store the 3-D engineering model and the metrology plan in the at least one database;
communicate the 3-D engineering model and the metrology plan to a supplier;
receive from the supplier a 3-D metrology model corresponding to the metrology plan and associated with the component; and
generate metrology data based on the a 3-D metrology model.

9. The system of claim 8, wherein the processor is further configured to show on the display the required geometric dimensions and tolerances in conjunction with the 3-D engineering model.

10. The system of claim 9, wherein the interface device receives the metrology plan via user selection of a subset of the required geometric dimensions and tolerances shown overlapped with the 3-D engineering model on the display.

11. The system of claim 8, wherein the processor is further configured to show on the display the 3-D metrology model overlaid with the 3-D engineering model.

12. The system of claim 8, wherein the processor is further configured to:
grade the component based on differences between the 3-D metrology model and the 3-D engineering model; and
selectively approve the supplier based on the grade.

13. The system of claim 12, wherein the processor is further configured to store the differences and the grade in the at least one database.

14. The system of claim 8, wherein the processor is further configured to create a 2-D drawing of the component based on the 3-D engineering model.

15. The system of claim 14, wherein the processor is configured to store the 2-D drawing in the at least one database.

16. The system of claim 15, wherein the at least one database includes:
an engineering database configured to store the 3-D engineering model; and
a purchasing database configured to store the metrology plan, the 3-D metrology model, and the 2-D drawing.

17. The system of claim 16, wherein the processor is further configured to:
grade the component based on differences between the 3-D metrology model and the 3-D engineering model;
selectively approve the supplier based on the grade; and
store the differences, the grade, and a supplier approval status in the purchasing database.

18. The system of claim 8, wherein the processor is further configured to render a 3-D metrology plan model based on the 3-D engineering model and the metrology plan.

19. The system of claim 18, wherein the processor is further configured to make a comparison of the 3-D metrology plan model with the 3-D metrology model.

20. A system for designing and validating a component, comprising:
an interface device configured to receive from a user:
desired geometry of the component;
required geometric dimensions and tolerances for the desired geometry; and
a metrology plan associated with the component;
an engineering database;
a purchasing database;
a display; and
a processor in communication with the interface device, the engineering database, the purchasing database, and the display, the processor being configured to:
render a 3-D engineering model of the component on the display based on the desired geometry;
show on the display the required geometric dimensions and tolerances in conjunction with the 3-D engineering model;
create a 2-D drawing of the component based on the 3-D engineering model;
render a 3-D metrology plan model based on the 3-D engineering model and the metrology plan;
communicate the 3-D engineering model, the 3-D metrology plan model, and the 2-D drawing to a supplier;
receive from the supplier a 3-D metrology model corresponding to the metrology plan and associated with the component;
generate metrology data based on the 3-D metrology model;
show the 3-D metrology model overlaid on the 3-D engineering model;
store the 3-D engineering model in the engineering database; and
store the 3-D metrology plan model, the 3-D metrology model, and the 2-D drawing in the purchasing database.
